(19) United States
(12) Patent Application Publication
(10) Pub. No.: US 2026/0170756 A1
(43) Pub. Date: Jun. 18, 2026

(54) INFORMATION PROCESSING APPARATUS

(71) Applicant: CANON KABUSHIKI KAISHA, Tokyo (JP)

(72) Inventors: RYOSUKE TANAKA, Tokyo (JP); KAZUNORI TAKAYAMA, Tokyo (JP)

(21) Appl. No.: 19/408,129

(22) Filed: Dec. 3, 2025

(30) Foreign Application Priority Data
Dec. 16, 2024 (JP) 2024-220209
Oct. 7, 2025 (JP) 2025-169777

(51) Int. Cl. G06T 17/00

(52) U.S. Cl. CPC G06T 17/00

(57) ABSTRACT

One or more information processing apparatuses, one or more methods, and one or more storage mediums are provided herein. One or more embodiments of an information processing apparatus includes one or more processors that operate to: acquire distance data on a distance to an object, generate a spatial model using the distance data, and evaluate whether a symmetric portion is present based on at least one of the distance data and the generated spatial model, wherein the one or more processors generate the spatial model based on a result of the evaluation to determine whether a symmetric portion is present.

### BACKGROUND

### Field of the Technology

The present disclosure relates to one or more embodiments of an information processing apparatus that generates a spatial model, and more particularly to one or more embodiments of an information processing apparatus that evaluates acquired distance data or a generated model and generates a model based on a result of the evaluation.

### Description of the Related Art

Recently prevalent sensors include Light Detection and Ranging (LiDAR) sensors (also known as Laser Imaging Detection and Ranging (LiDAR) sensors), which irradiate objects with laser light and measure the time of flight of the reflected light to measure the distance to an object. These sensors have been mounted on information terminals, such as smartphones and tablet terminals.

Such information terminals can easily generate a three-dimensional computer graphics model or a two-dimensional map (hereinafter collectively referred to as a “spatial model” or simply a “model”) by scanning an actual object with a LiDAR sensor. Models generated by information terminals can be viewed from any angle, combined with other images or models, and widely applied not only in the fields of art and design but also in combination with technologies such as Virtual Reality (VR), Augmented Reality (AR), and Mixed Reality (MR). In such applications, it is demanded that a model serving as a material is to accurately and precisely model a target object required for each intended use.

Various techniques have been proposed in the past to improve model quality. For example, Japanese U.S. Pat. No. 7,133,971 describes a three-dimensional model generation apparatus designed for as-built management at construction sites, which enables generation of a high-quality model that excludes unnecessary objects. This apparatus removes regions unnecessary for model generation from data obtained through measurement by a measurement unit using classification data generated through machine learning, and generates a model using the data from which unnecessary regions have been removed. Thus, a high-quality model free from unwanted elements, such as workers and heavy machinery, can be generated. An information terminal equipped with a distance measurement sensor, such as a Light Detection and Ranging (LiDAR) sensor, cannot correctly model a target space when an object with high reflectance, such as a mirror (hereinafter simply referred to as a “mirror”), is present during model generation.

### SUMMARY

The present disclosure addresses the aforementioned issues or inefficiencies. The present disclosure is directed to providing one or more embodiments of an information processing apparatus, and related methods and storage mediums, capable of preventing the generation of incorrectly shaped models and enabling the generation of correctly shaped models in the process of generating models that include specular surfaces. According to one or more aspects of the present disclosure, at least one embodiment of an information processing apparatus may include one or more processors that operate to: acquire distance data on a distance to an object, generate a spatial model using the distance data, and evaluate whether a symmetric portion is present based on at least one of the distance data and the generated spatial model, wherein the one or more processors generate the spatial model based on a result of the evaluation to determine whether a symmetric portion is present.

According to other aspects of the present disclosure, one or more additional information processing apparatuses, one or more methods, and one or more storage mediums are discussed herein. Features of the present disclosure will become apparent from the following description of embodiments with reference to the attached drawings. The following description of embodiments is described by way of example.

### BRIEF DESCRIPTION OF THE DRAWINGS

FIG. 1 is a diagram illustrating at least one embodiment of a hardware configuration of at least one information processing apparatus according to one or more aspects of the present disclosure.

FIG. 2 is a flowchart illustrating at least one embodiment of a model generation process performed by at least one information processing apparatus according to one or more aspects of the present disclosure.

FIG. 3 is a diagram illustrating at least one embodiment of a hardware configuration of at least one information processing apparatus according to one or more aspects of the present disclosure.

FIG. 4 is a flowchart illustrating at least one embodiment of a model generation process performed by at least one information processing apparatus according to one or more aspects of the present disclosure.

FIG. 5 is a mode transition diagram of at least one embodiment of an information processing apparatus according to one or more aspects of the present disclosure.

### DESCRIPTION OF THE EMBODIMENTS

The present disclosure addresses the aforementioned issues or inefficiencies. For example, when a LiDAR sensor measures the distance to a specular surface, emitted laser light undergoes specular reflection on the specular surface, and the light returning directly to an information terminal becomes extremely weak (when the measurement is performed from a direction not perpendicular to the mirror surface). Most of the laser light is specularly reflected by the specular surface and then strikes a certain object A at the reflection destination. The laser light reflected by the object travels back along the same optical path, is reflected again by the specular surface, and returns to the information terminal. For the LiDAR sensor to correctly measure the specular surface, the laser light should ideally travel only the round-trip distance between the terminal and the specular surface. However, the laser light additionally travels the round-trip distance between the mirror surface and the object A, causing the specular surface to be measured as a longer distance than its actual distance. Generating a model based on this incorrect distance data causes the information terminal to generate an erroneous model that differs from the actual shape of the target space.

The present disclosure is directed to providing one or more embodiments of an information processing apparatus, and related methods and storage mediums, capable of preventing the generation of incorrectly shaped models and enabling the generation of correctly shaped models in the process of generating models that include specular surfaces.

One or more embodiments of the present disclosure will be described. In one or more embodiments, a model is generated based on distance data acquired by a distance measurement unit as well as position data and orientation data acquired by a position and orientation information acquisition unit, and the model is evaluated using only coordinates representing the shape of the model. In one or more additional embodiments, in addition to the configurations of the one or more embodiments, a model is generated by mapping an image captured by an image capturing unit as a texture, and the model is evaluated using not only coordinates representing the shape of the model but also colors and features of the texture.

### One or More Embodiments

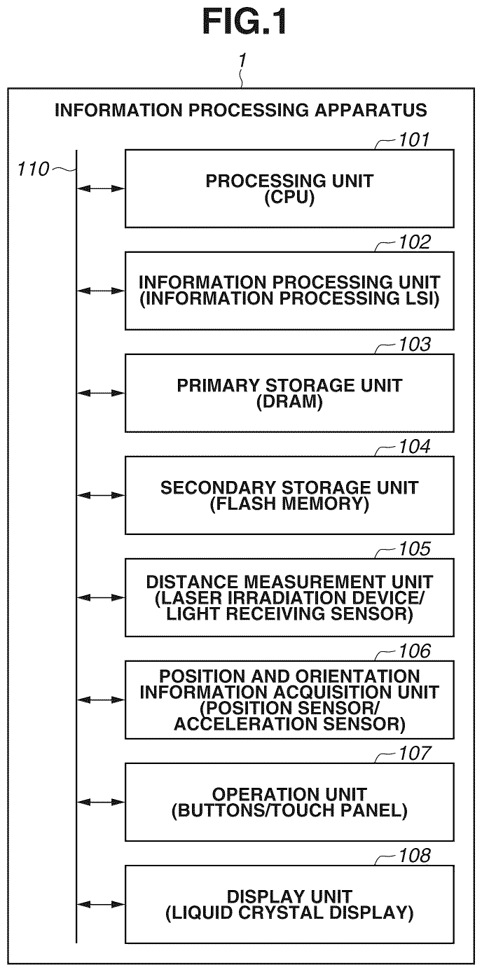

One or more embodiments will now be described. FIG. 1 illustrates at least one embodiment of a hardware configuration of an information processing apparatus 1 according to one or more aspects of the present disclosure. The information processing apparatus 1 includes a processing unit 101, such as a Central Processing Unit (CPU), an information processing unit 102, such as a Large-Scale Integration (LSI) circuit or processor, a primary storage unit 103, such as a volatile main memory device, a secondary storage unit 104, such as a non-volatile auxiliary memory device, a distance measurement unit 105, such as a laser irradiation device and a light receiving device (sensor), a position and orientation information acquisition unit 106, such as a position sensor and an acceleration sensor, an operation unit 107 including buttons, a touch panel, and/or other operation members, and a display unit 108, such as a liquid crystal display. Each component of the information processing apparatus 1 exchanges data via a bus 110.

The processing unit 101 controls the hardware components other than the processing unit 101 within the information processing apparatus 1. The processing unit 101 performs control for each component illustrated in FIG. 1, such as parameter settings and operation instructions. The information processing unit 102 performs arithmetic processing on distance data acquired by the distance measurement unit 105 and position data and orientation data acquired by the position and orientation information acquisition unit 106, as well as model generation processing and model evaluation processing. The primary storage unit 103 temporarily stores data used by the processing unit 101 and the information processing unit 102. The secondary storage unit 104 stores data used by the processing unit 101 and models generated by the information processing unit 102. The distance measurement unit 105 emits laser light toward a measurement target object, receives reflected light, and measures the time of reception of the reflected light, thus measuring the distance to the target object. The position and orientation information acquisition unit 106 measures the position and inclination of the information processing apparatus 1 and acquires position data and orientation data. The operation unit 107 inputs instructions from a user to the processing unit 101. The display unit 108 displays a generated model and presents the model to the user. The operations described below as being performed by the information processing apparatus 1 are executed by the processing unit 101 or by a corresponding unit of the information processing apparatus 1 in response to instructions from the processing unit 101.

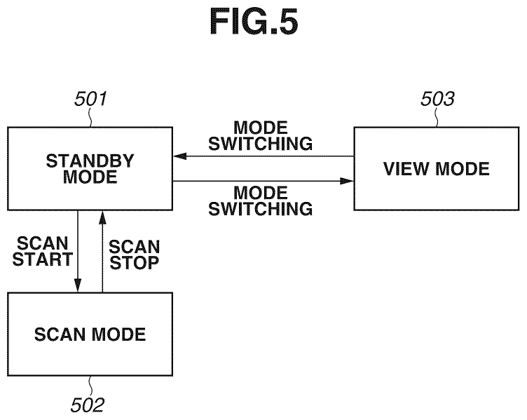

A mode transition diagram for the information processing apparatus 1 is illustrated in FIG. 5. The information processing apparatus 1 includes at least a standby mode 501 and a scan mode 502, and may further include a view mode 503. The initial state is the standby mode 501. In the standby mode 501, the information processing apparatus 1 waits until scanning of a target object is started. In the standby mode 501, the user adjusts the angle of the information processing apparatus 1 toward the target object to be scanned. After the user confirms the angle of the information processing apparatus 1 and presses a button of the operation unit 107 having a function of starting scanning, the information processing apparatus 1 transitions to the scan mode 502. In the scan mode 502, the information processing apparatus 1 performs model generation processing. In response to the user pressing a button of the operation unit 107 having a function of stopping scanning, the information processing apparatus 1 transitions to the standby mode 501. In the standby mode 501, in response to the user pressing a button of the operation unit 107 having a function of transitioning to the view mode 503, the information processing apparatus 1 transitions to the view mode 503. In the view mode 503, the display unit 108 of the information processing apparatus 1 displays a generated model according to user input from the operation unit 107, and, depending on the input, displays the model in an enlarged, reduced, rotated, and/or moved state. In the view mode 503, in response to the user pressing a button of the operation unit 107 having a function of transitioning to the standby mode 501, the information processing apparatus 1 transitions to the standby mode 501.

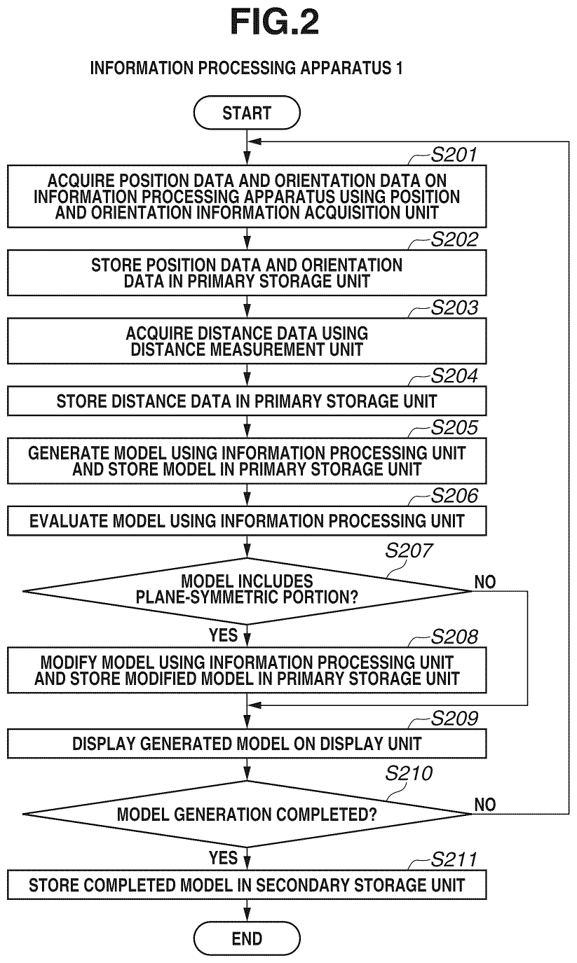

FIG. 2 illustrates a flowchart of at least one embodiment of a model generation process that is performed by at least one embodiment of an information processing apparatus 1 according to one or more aspects of the present disclosure. Unless otherwise specified, each step in the flowchart illustrated in FIG. 2 is performed by the processing unit 101 or by a corresponding unit of the information processing apparatus 1 in response to an instruction from the processing unit 101.

In response to the user operating the operation unit 107 to cause the information processing apparatus 1 to transition to the scan mode 502, the model generation process is started.

In FIG. 2, after the model generation process is started, the processing proceeds to step S201. In step S201, the position and orientation information acquisition unit 106 acquires position data and orientation data on the information processing apparatus 1.

Subsequently, in step S202, the processing unit 101 stores the position data and orientation data acquired by the position and orientation information acquisition unit 106 in the primary storage unit 103.

Next, in step S203, the distance measurement unit 105 acquires distance data.

Then, in step S204, the processing unit 101 stores the distance data acquired by the distance measurement unit 105 in the primary storage unit 103.

Next, in step S205, the information processing unit 102 generates a model using the position data and orientation data and the distance data stored in the primary storage unit 103, and stores the generated model data in the primary storage unit 103.

The model generated by the information processing apparatus 1 is similar to a general computer graphics model. Specifically, the model is represented as a collection of numerous polygonal data elements, referred to as polygons. Each polygon includes vertices, edges connecting two vertices, and faces formed by three or more edges. A model or each polygon of the model may include material information, including, but not limited to texture, transparency, and/or reflectance. Model generation is performed using a known method. Specifically, the information processing unit 102 computes three-dimensional absolute coordinates of vertices, edges, and faces representing an object surface based on the position data and orientation data on the information processing apparatus 1 acquired by the position and orientation information acquisition unit 106 and the distance data acquired by the distance measurement unit 105. During model generation, vertices forming polygons may be uniformly generated on the surface of a target object or may be intensively generated at feature points or portions having characteristic shapes with large surface curvature. The method of representing a model and the data structure forming the model are not limited to those described above.

Then, in step S206, the information processing unit 102 evaluates the generated model.

Model evaluation in step S206 is intended to determine whether the model includes a plane-symmetric portion, and a known method, such as a technique utilizing a Hough transform, is employed. Specifically, any two vertices of the model are extracted, and the relative position of the two points and the orientation of a face including the two points are evaluated. The face orientation may be evaluated not only based on the extracted vertices but also using the coordinates of vertices, edges, and faces in the vicinity of the extracted vertices.

In a case where the information processing unit 102 determines, based on the evaluation of the relative position and face orientation, that the extracted pair of vertices is positioned in a plane-symmetric manner, the information processing unit 102 regards the pair of vertices as a candidate for a pair of symmetric points and obtains the coordinates and angle of the midpoint of the line segment connecting the two points. Using these pieces of information, a voting process is performed in a parameter space defining the equation of a symmetry-axis plane. The above process is performed for all or some of the pairs of points in the model, and then a coordinate having a large accumulated number of votes in the parameter space is extracted to obtain a symmetry-axis plane of a plane-symmetric object that is present in the model.

Then, in step S207, the information processing unit 102 determines whether the generated model includes a plane-symmetric portion. Whether the model includes a plane-symmetric portion can be determined based on whether there is any coordinate in the parameter space at which the accumulated number of votes, obtained in step S206, exceeds a predetermined value.

In step S207, if the information processing unit 102 determines that the model includes a plane-symmetric portion (YES, in step S207), the processing proceeds to step S208. If the information processing unit 102 determines that the model includes no plane-symmetric portion (NO, in step S207), the processing proceeds to step S209.

If the information processing unit 102 determines in step S207 that the model includes a plane-symmetric portion, then in step S208, the information processing unit 102 modifies the model and stores the modified model in the primary storage unit 103. The model modification involves deleting one side that is determined to have low accuracy from the portion forming the plane-symmetric portion of the model. Model accuracy is evaluated with reference to the positions and distributions of, and the connectivity among, the vertices, edges, and faces forming polygons. Thereafter, a polygon representing a plane is formed at a position corresponding to the symmetry-axis plane of the model. In a case where each polygon of the model has material information or equivalent information, a property having characteristics of a mirror may be set for the plane formed in this process.

In step S209 after step S208, the display unit 108 displays the model stored in the primary storage unit 103.

Thereafter, in step S210, the processing unit 101 determines whether model generation has been completed. The processing unit 101 determines that model generation has been completed if the user operates the operation unit 107 and the information processing apparatus 1 exits the scan mode 502 (YES, in step S210).

Then, in step S211, the completed model is stored in the secondary storage unit 104.

According to one or more embodiments described above, the information processing apparatus 1 can modify incorrectly shaped models resulting from the inability to correctly measure the distance to a specular surface, thus generating correctly shaped model.

### One or more Additional Embodiments

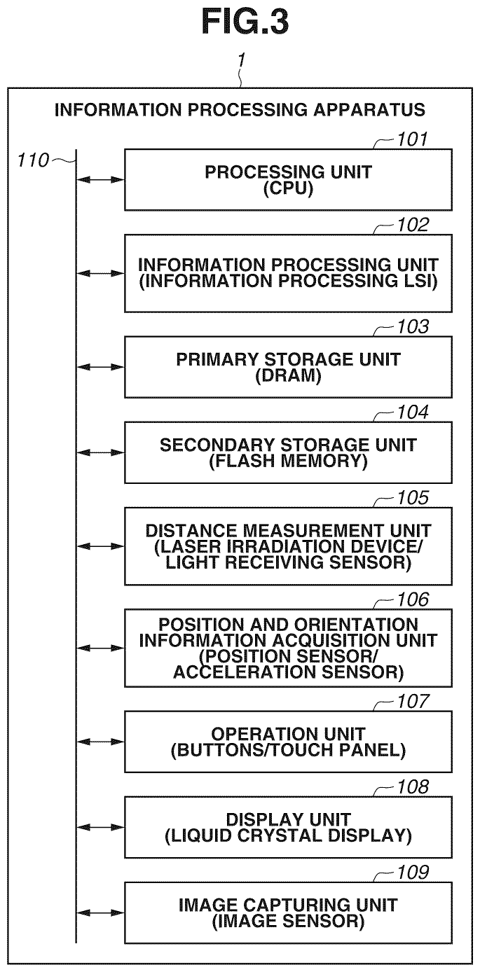

One or more additional embodiments will now be described. FIG. 3 illustrates at least one embodiment of a hardware configuration of an information processing apparatus 1 according to one or more aspects of the present disclosure. The information processing apparatus 1 according to one or more additional embodiments includes, in addition to the components in the one or more embodiments described above, an image capturing unit 109 including an image sensor, other sensors, and associated optical components. The configuration other than the image capturing unit 109 in the one or more additional embodiments is the same as that of the one or more embodiments. The image capturing unit 109 collects light from a target object serving as a subject, forms an image on the image sensor, and converts the image into digital data. In the information processing apparatus 1 according to one or more additional embodiments, the processing unit 101 additionally controls the image capturing unit 109. The information processing unit 102 performs arithmetic processing on distance data acquired by the distance measurement unit 105, position data and orientation data acquired by the position and orientation information acquisition unit 106, and image data captured by the image capturing unit 109. The processing unit 101 then performs model generation processing and model evaluation processing, using the distance data, position data, orientation data, and image data. The information processing unit 102 also processes an image captured by the image capturing unit 109 during model generation so that the display unit 108 can display a live view image. The display unit 108 displays a live view image processed by the information processing unit 102 in addition to a model generated by the information processing unit 102.

The mode configuration of the information processing apparatus 1 is the same as that of the one or more embodiments. In the one or more additional embodiments, in the standby mode 501 and the scan mode 502, the display unit 108 may display a live view image captured by the image capturing unit 109 and processed by the information processing unit 102. The user can perform scanning work while viewing the live view image to check the state of the target object.

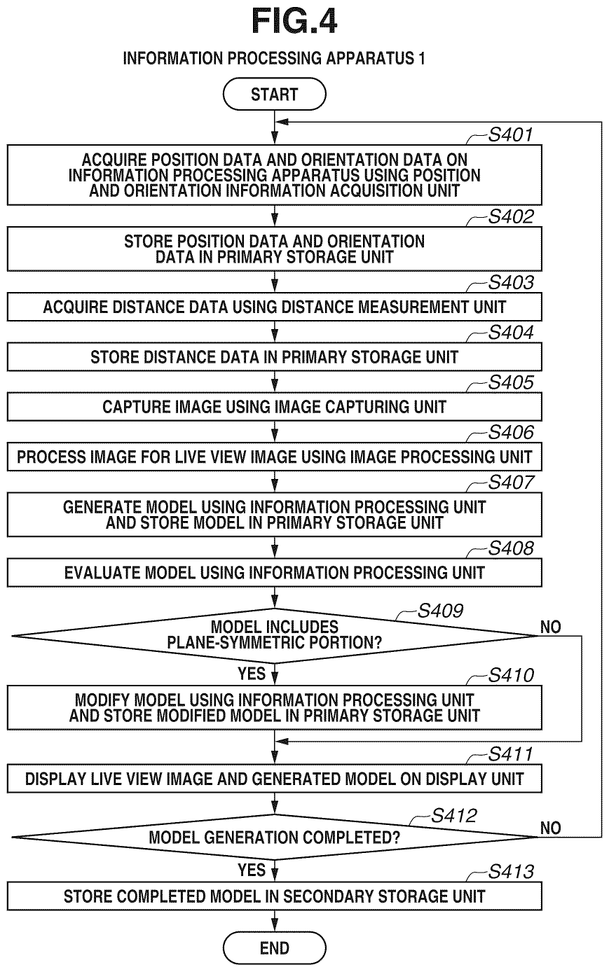

FIG. 4 illustrates a flowchart of at least one embodiment of a model generation process performed by the information processing apparatus 1 in one or more additional embodiments. Differences from the one or more embodiments discussed above are that steps S405 and S406 related to the image capturing unit 109 are added, the model generation method in step S407 and the model evaluation method in step S408 are different, and the information displayed in step S411 is different.

When the user operates the operation unit 107 to cause the information processing apparatus to transition to the scan mode 502, the model generation process is started. After starting the model generation process, the processing proceeds to step S401 in FIG. 4. The operations from step S401 to step S404 for one or more additional embodiments are the same as the those from step S201 to step S204 in the one or more embodiments discussed above.

In step S405 after step S404, the image capturing unit 109 captures an image of a target object serving as a subject.

Then, in step S406, the information processing unit 102 processes the image captured by the image capturing unit 109 as a live view image. This processing is similar to image processing performed by a general digital camera, such as correction processing for pixel defects and distortion, and development processing.

Then, in step S407, the information processing unit 102 generates a model using the position data, orientation data, and distance data stored in the primary storage unit 103, and stores the generated model data in the primary storage unit 103. Model generation is performed in a manner similar to that in the one or more embodiments, except that in one or more additional embodiments, the image data captured by the image capturing unit 109 may be mapped as a texture.

Then, in step S408, the information processing unit 102 evaluates the generated model.

Model evaluation in step S408 is intended to determine whether the model includes a plane-symmetric portion, as in the one or more embodiments discussed above. In the one or more embodiments discussed above, the model evaluation focuses only on the model shape, specifically, the coordinates of constituent components of the model, whereas in one or more additional embodiments, information about colors and features of an image mapped as a texture to the model is also used. Specifically, when any two vertices of the model are extracted and the relative position of the two points and the orientation of a face including the two points are evaluated, the colors and features of the texture are also evaluated. Each texture color of the pair of vertices may be evaluated by determining whether the color value (such as a color code) of each vertex falls within a predetermined range. The relative position of the two points, the orientation of a face including the two points, and the color similarity of the two points are evaluated, and in a case where the extracted pair of vertices is determined to be positioned in a plane-symmetric manner, the pair of vertices is regarded as a candidate for a pair of symmetric points. Colors and features of the texture-mapped image may be evaluated not only based on extracted vertices but also using the coordinates of vertices, edges, and faces in the vicinity of the extracted vertices, as in the case of face orientation. Based on the evaluation of the relative position, face orientation, and colors and features of the texture, a symmetry-axis plane of a symmetric object is obtained as in the one or more embodiments discussed above. Using information about colors and features of an image mapped as a texture of the model enables an evaluation of a symmetric structure of a model with increased accuracy.

Then, in step S409, the information processing unit 102 determines whether the generated model includes a plane-symmetric portion. If the information processing unit 102 determines that the model includes a plane-symmetric portion (YES, in step S409), the processing proceeds to step S410. If the information processing unit 102 determines that the model includes no plane-symmetric portion (NO, in step S409), the processing proceeds to step S411. In step S409, if the information processing unit 102 determines that the model includes a plane-symmetric portion, then in step S410, the information processing unit 102 modifies the model and stores the modified model in the primary storage unit 103. The model modification is performed in a manner similar to that in the one or more embodiments discussed above.

In step S411 after step S410, the display unit 108 displays a live view image processed by the information processing unit 102 and the model generated by the information processing unit 102. In step S411, the model is to be displayed, whereas the live view image may optionally be displayed. In a case where both the live view image and the model are displayed, the model is displayed superimposed on the live view image. The model may be displayed as an opaque or semi-transparent surface model representing polygons by faces, or as a wireframe model representing polygons by edges, or using any other representation method. In this case, it is assumed that the model is not mapped with an image captured by the image capturing unit 109 as a texture. In a case where only the model is displayed without displaying the live view image, the model is one that is mapped with an image captured by the image capturing unit 109 as a texture. In either case, the display unit 108 presents the model with the colors of the target object represented by the model superimposed. This enables the user, during scanning of the target object, to easily grasp which parts of the target object are being modeled. The operations from step S412 to step S413 in one or more additional embodiments are the same as those from step S210 to step S211 in one or more embodiments discussed above.

According to one or more additional embodiments described above, the information processing apparatus 1 can perform model evaluation with higher accuracy than in the one or more embodiments discussed above by using an image captured by the image capturing unit 109. This enables the information processing apparatus 1 to modify, with increased accuracy, incorrectly shaped models resulting from the inability to correctly measure the distance to a specular surface, and to generate correctly shaped models. In addition, the configuration of one or more additional embodiments enables the display unit 108 to present which parts of the target object are modeled and which regions are not modeled, thus enabling the user to efficiently perform a high-quality model generation process.

The present disclosure has been described in detail above based on its embodiments, but the present disclosure is not limited to these specific embodiments, and various forms within the scope of the gist of the present disclosure are included in the present disclosure. Furthermore, each embodiment described above merely illustrates embodiments of the present disclosure, and the embodiments can be appropriately combined.

In the present description, the model to be generated is set as a three-dimensional model; however, the model to be generated and evaluated may alternatively be a two-dimensional model.

The information processing apparatus 1 for a particular embodiment may take any form other than as described in the particular embodiment. The information processing apparatus 1 may take any form of computer, such as a smartphone, a tablet terminal, or a wearable device, including a head-mounted display, or may also take the form of a digital still camera, a digital video camera, a vehicle, such as an automobile, an aircraft, such as a drone, or a robot for various applications. The apparatus may be embodied in these devices themselves or as a device mounted on them, but is not limited thereto.

For example, as in the case of a drone and its controller, the hardware components illustrated in the embodiments may be distributed across a plurality of devices, which operate in cooperation with each other. In addition, the various types of control described in conjunction with the flowcharts described-above may be executed by a single processor or circuit, or by a plurality of processors or circuits sharing the processing to control the entire apparatus.

The information processing apparatus of the present disclosure can prevent generation of incorrectly shaped models and generate correctly shaped models in the process of generating models with specular surfaces.

### Other Embodiments

Embodiment(s) of the present disclosure may also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)^{TM}), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims priority to, and the benefit of, Japanese Patent Application No. 2024-220209, filed Dec. 16, 2024, and Japanese Patent Application No. 2025-169777, filed Oct. 7, 2025, which are hereby incorporated by reference herein in their entireties.

What is claimed is:

1. An information processing apparatus comprising:
one or more processors that operate to:
acquire distance data on a distance to an object;
generate a spatial model using the distance data; and
evaluate whether a symmetric portion is present based on at least one of the distance data and the generated spatial model,
wherein the one or more processors generate the spatial model based on a result of the evaluation to determine whether a symmetric portion is present.

2. The information processing apparatus according to claim 1, wherein the generated spatial model is a three-dimensional model, and the one or more processors evaluate whether a plane-symmetric portion is present based on at least one of the distance data and the generated spatial model.

3. The information processing apparatus according to claim 1, wherein the generated spatial model is a two-dimensional model, and the one or more processors evaluate whether a line-symmetric portion is present based on at least one of the distance data and the generated spatial model.

4. The information processing apparatus according to claim 1, wherein the one or more processors generate the generated spatial model by changing at least one of presence or absence, a position, a shape, a size, an angle, connectivity, or a visual or physical property including color, material, and texture, of at least one of vertices, edges, lines, or faces of the model based on the result of the evaluation to determine whether a symmetric portion is present.

5. The information processing apparatus according to claim 1, further comprising an image capturing sensor or an image sensor that operates to capture image data on an object, wherein the one or more processors evaluate at least one of the distance data, the generated spatial model, and the image data.

6. The information processing apparatus according to claim 5, wherein the one or more processors evaluate each piece of data after completion of both the distance acquisition and the image capturing or after completion of the model generation.

7. The information processing apparatus according to claim 5, wherein the one or more processors evaluate each piece of data before completion of at least one of the distance acquisition, the image capturing, and the model generation.

8. The information processing apparatus according to claim 1, wherein the one or more processors further operate to generate at least one of a vertex, an edge, a line, or a face on an axis of symmetry.

9. The information processing apparatus according to claim 1, wherein the one or more processors further operate to delete one of a plurality of models in the symmetric portion that has been evaluated as having low accuracy.

10. The information processing apparatus according to claim 9, wherein the one or more processors further operate to evaluate model accuracy based on: a number of vertices, edges, and faces of a model per unit volume of the model; uniformity of density of the vertices, the edges, and the faces of the model; connectivity of the vertices, the edges, and the faces of the model with adjacent elements; and a texture image to be mapped, in a plane-symmetric portion.
